(19) United States
(12) Patent Application Publication
(10) Pub. No.: US 2026/0181419 A1
(43) Pub. Date: Jun. 25, 2026

(54) ADAPTIVE ANTENNA SELECTION USING GENERATIVE ARTIFICIAL INTELLIGENCE-BASED LINK MODELING

(71) Applicant: QUALCOMM Incorporated, San Diego, CA (US)

(72) Inventors: Himanshu JOSHI, San Jose, CA (US); Rohit BHASI THAZHATH, San Diego, CA (US); Taesang YOO, San Diego, CA (US); Sandeep RAMANNAVAR, San Diego, CA (US); June NAMGOONG, San Diego, CA (US); Vinay CHANDE, San Diego, CA (US); Madhup CHANDRA, San Diego, CA (US)

(21) Appl. No.: 18/999,258

(22) Filed: Dec. 23, 2024

(51) Int. Cl. H04W 24/02; H04B 7/08

(52) U.S. Cl. CPC H04W 24/02; H04B 7/0802

(57) ABSTRACT

Various aspects of the present disclosure generally relate to wireless communication. In some aspects, a user equipment (UE) may input, during a reference time period, a prompt into a generative artificial intelligence (AI) model, wherein the prompt is associated with a set of one or more past time resources. The UE may generate, during the reference time period and using the generative AI model, a sequence of tokens corresponding to a set of one or more future time resources, wherein the sequence of tokens represents one or more predicted communications between the UE and a network node during the set of one or more future time resources. The UE may communicate, during the one or more future time resources, according to an adaptive receive diversity (ARD) state, wherein the ARD state is selected by the UE according to the one or more predicted communications. Numerous other aspects are described.

### FIELD OF THE DISCLOSURE

Aspects of the present disclosure generally relate to wireless communication and specifically relate to techniques, apparatuses, and methods associated with adaptive antenna selection using generative artificial intelligence-based link modeling.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

A user equipment (UE) may improve signal quality, power consumption properties, and/or reliability by dynamically selecting a signal path and/or or combining signals received by selectively powering one or more receive antennas by using a control mechanism of the UE called an adaptive receive diversity (ARD) state machine that may manage how and when the UE switches receive diversity modes (e.g., selects a quantity of activated and/or powered on receive antennas).

Some ARD algorithms may include and/or be based on rules-based heuristics, and whenever they are based on statistics, some ARD algorithms may be based on historical statistics collected during a time duration (e.g., a time window, timeframe, duration of time, among other examples, that may be predefined according to original equipment manufacturer specifications, wireless communications standards specifications, and/or service provider specifications and/or implementations). However, because some ARD algorithms may rely on heuristic rules and/or historical data, the time duration and/or the heuristic rules may be inflexible and thus may not be adaptable to different environmental, network, channel, and/or traffic conditions, and the ARD algorithms may not be configured to generate and/or predict hypothetical futures and/or scenarios and/or may not be configured to adjust the duration of time during which stats are collected for inputting into the ARD algorithms, each of which may limit the effectiveness of ARD algorithms and/or may result in an insufficient quantity of powered receive antennas (e.g., for a particular scenario).

A UE implementing an AI-based Foundation Model such as a generative AI link model may predict future communications such that the ARD component may use (e.g., take into account) and/or input the predictions into one or more ARD algorithms for selecting an ARD state of the UE. For example, using the generative AI link Model approach, the UE may proactively predict one or more future scenarios which includes predicting a quantity of antenna via which to receive a network signal. The UE may conserve power by adaptively selecting a quantity of receive antennas to activate and/or deactivate. For example, the ARD algorithms may use the predictions to select a next ARD state for the UE, which may include remaining in a current ARD state, switching to a lower ARD state, and/or switching to a higher ARD state, in accordance with the future predictions. In some aspects, the UE implementing the ARD algorithms may select an ARD state based on the one or more predicted communications according to one or more communication goals and/or priorities of the UE, such as increasing throughput, increasing reliability, and/or increasing efficiency.

Some aspects described herein relate to an apparatus for wireless communication at a UE. The apparatus may include one or more memories and one or more processors coupled to the one or more memories. The one or more processors may be configured to input, during a reference time period, a prompt into a generative artificial intelligence (AI) model, wherein the prompt is associated with a set of one or more past time resources. The one or more processors may be configured to generate, during the reference time period and using the generative AI model, a sequence of tokens corresponding to a set of one or more future time resources, wherein the sequence of tokens represents one or more predicted communications between the UE and a network node during the set of one or more future time resources. The one or more processors may be configured to communicate, with the network node during the set of one or more future time resources, according to an ARD state, wherein the ARD state is selected by the UE according to the one or more predicted communications.

Some aspects described herein relate to a method of wireless communication performed by a UE. The method may include inputting, during a reference time period, a prompt into a generative AI model, wherein the prompt is associated with a set of one or more past time resources. The method may include generating, during the reference time period and using the generative AI model, a sequence of tokens corresponding to a set of one or more future time resources, wherein the sequence of tokens represents one or more predicted communications between the UE and a network node during the set of one or more future time resources. The method may include communicating, with the network node during the set of one or more future time resources, according to an ARD state, wherein the ARD state is selected by the UE according to the one or more predicted communications.

Some aspects described herein relate to a non-transitory computer-readable medium that stores a set of instructions for wireless communication by a UE. The set of instructions, when executed by one or more processors of the UE, may cause the UE to input, during a reference time period, a prompt into a generative AI model, wherein the prompt is associated with a set of one or more past time resources. The set of instructions, when executed by one or more processors of the UE, may cause the UE to generate, during the reference time period and using the generative AI model, a sequence of tokens corresponding to a set of one or more future time resources, wherein the sequence of tokens represents one or more predicted communications between the UE and a network node during the set of one or more future time resources. The set of instructions, when executed by one or more processors of the UE, may cause the UE to communicate, with the network node during the set of one or more future time resources, according to an ARD state, wherein the ARD state is selected by the UE according to the one or more predicted communications.

Some aspects described herein relate to an apparatus for wireless communication. The apparatus may include means for inputting, during a reference time period, a prompt into a generative AI model, wherein the prompt is associated with a set of one or more past time resources. The apparatus may include means for generating, during the reference time period and using the generative AI model, a sequence of tokens corresponding to a set of one or more future time resources, wherein the sequence of tokens represents one or more predicted communications between the UE and a network node during the set of one or more future time resources. The apparatus may include means for communicating, with the network node during the set of one or more future time resources, according to an ARD state, wherein the ARD state is selected by the UE according to the one or more predicted communications.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a transmit chain and a receive chain of a user equipment (UE), in accordance with the present disclosure.

FIG. 4 is a diagram illustrating an example of adaptive receive diversity (ARD) on a physical downlink control channel and an example of ARD on a bandwidth part, in accordance with the present disclosure.

FIG. 5 is a diagram illustrating an example of a generative artificial intelligence (AI) foundational model including a grant prediction generative link model, in accordance with the present disclosure.

FIG. 6 is a diagram of an example associated with adaptive antenna selection using generative artificial intelligence-based link modeling, in accordance with the present disclosure.

FIG. 7 is a diagram illustrating an example of ARD with generative AI-based link modeling, in accordance with the present disclosure.

FIG. 8 is a diagram illustrating an example architecture of a functional framework for radio access network intelligence enabled by data collection, in accordance with the present disclosure.

FIG. 9 is a diagram illustrating an example process performed, for example, at a UE or an apparatus of a UE, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may improve signal quality, power consumption properties, and/or reliability by dynamically selecting a signal path and/or or combining signals received by selectively powering one or more receive antennas by using a control mechanism of the UE called an adaptive receive diversity (ARD) state machine that may manage how and when the UE switches receive diversity modes. In some examples, using an ARD state machine may be referred to as using ARD techniques. The ARD state machine may leverage diversity of various versions of a same signal, each of which may be differently affected by various environmental, network, channel, and/or communications traffic conditions. For example, the UE may receive different versions of the same signal via multiple, often independent, propagation paths to mitigate factors that may negatively affect communications at the UE, such as fading, interference, and/or multipath propagation. The UE may use one or more algorithms to dynamically adjust the quantity of powered (e.g., switched on, activated) receive antennas. The one or more algorithms may collectively be referred to as ARD and/or ARD algorithms, and may be executed and/or calculated by using the ARD state machine. In some examples, the ARD state machine may perform one or more functions according to one or more outputs of the ARD algorithms. In some examples, the one or more algorithms may facilitate various ARD techniques. For example, ARD techniques may include the UE implementing the one or more algorithms to select a most (e.g., probabilistically) suitable quantity of receive antennas to power.

In some examples, the ARD algorithms may take a current state of the UE, one or more transpiring wireless communication procedures, and/or predicted traffic type, into account when calculating a quantity of receive antennas to power. For example, the ARD may down-power to two receive antennas (e.g., from a quantity of powered receive antennas that is greater than two) when a control channel communication (e.g., physical downlink control channel (PDCCH), physical sidelink control channel (PSCCH) is expected and/or detected. In some other examples, the ARD may down-power to a relatively small quantity of receive antennas from a quantity of powered receive antennas that is greater than the relatively small quantity when a low scheduling rate condition criterion is satisfied (e.g., may enter a connected discontinuous reception mode (e.g., in which no Rx antenna are activated and/or powered), a 2Rx, 3Rx, 4Rx, 5 Rx, 6Rx, 7Rx, 8Rx, etc. mode from a mode including a larger quantity of activated receive antennas). In some other examples, the ARD state machine may up-power to increase a quantity of activated receive antennas (e.g., may enter a 2Rx, 3Rx, 4Rx, 5 Rx, 6Rx, 7Rx, and/or 8Rx mode from a mode including fewer activated receive antennas, and/or from a connected discontinuous reception mode (e.g., in which no Rx antenna are activated and/or powered)), for example, when a burst (e.g., a quantity of communications, such as reference signals, that occur relatively closely in time and/or may be separated from other bursts by a larger duration and/or periodicity than a periodicity and/or separation in time between communications in the burst) and/or a resource grant (e.g., a downlink scheduled grant, a dynamic grant, a semi-persistent scheduling (SPS) grant, a proportional fair grant (e.g., a dynamic grant that allocates resources proportionally to data requirements and channel conditions of the UE), a best effort grant (e.g., a grant that allocates resources, when available, for non-critical data and/or background operations)) is expected, and/or detected.

However, some ARD algorithms may include and/or be based on rules-based heuristics, and whenever they are based on statistics, some ARD algorithms may be based on historical statistics collected during a time duration (e.g., a time window, timeframe, duration of time, among other examples, that may be predefined according to original equipment manufacturer specifications, wireless communications standards specifications, and/or service provider specifications and/or implementations). However, because some ARD algorithms may rely on heuristic rules and/or historical data, the time duration and/or the heuristic rules may be inflexible and thus may not be adaptable to different environmental, network, channel, and/or traffic conditions, and the ARD algorithms may not be configured to generate and/or predict hypothetical futures and/or scenarios and/or may not be configured to adjust the duration of time during which stats are collected for inputting into the ARD algorithms, each of which may limit the effectiveness of ARD algorithms and/or may result in an insufficient quantity of powered receive antennas (e.g., for a particular scenario).

Various aspects relate generally to prediction using link modeling. Some aspects more specifically relate to the modeling of a future scenario, including a resource grant prediction, in accordance with data associated with an adjustable set of one or more past time resources. In some aspects, a UE may input, during a reference time period, a prompt into a generative artificial intelligence (genAI) model. In some aspects, the prompt may include a duration of the adjustable set of one or more past time resources, a hypothetical future scenario to be taken into account by the genAI model when predicting whether the resource grant will be communicated, and/or a request for a set of information according to a task-specific head of the genAI model. In some aspects, the UE (e.g., one or more components of the UE) may predict, during the reference time period and using the genAI model, a resource grant associated with the set of one or more future time resources in accordance with information associated with the adjustable set of one or more past time resources. The UE may communicate with a network node during the set of one or more future time resources, according to an ARD state. In such aspects, the ARD state may be selected by the UE (e.g., one or more ARD components of the UE) in accordance with predicting the resource grant.

In some aspects, the genAI model may be trained using historical communications data associated with network node traffic load, network traffic conditions, traffic class, outer loop operations, or a proportionally fair parameter associated with the network node. In some aspects, the genAI model may output a prediction for each time resource of the set of one or more future time resources by generating one or more tokens corresponding to each future time resource of the set of one or more future time resources. In some aspects, the prompt may include an indication that the genAI model is to take a hypothetical future scenario into account when predicting whether the resource grant will be communicated.

Particular aspects of the subject matter described in this disclosure can be implemented to realize one or more of the following potential advantages. In some examples, the described techniques can be used to conserve energy, increase reliability, decrease latency, and power consumption. For example, by the UE inputting the prompt into the genAI model, the genAI model may be able to predict a future according to information requested by the UE that may be relevant to one or more communication conditions of the UE. For example, by the prompt including the duration of the adjustable set of one or more past time resources, the hypothetical future scenario to be taken into account by the genAI model when predicting whether the resource grant will be communicated, and/or the request for a set of information according to a task-specific head of the genAI model, the UE may be able to customize an output of the genAI model such that the UE receives less, but more relevant, information and may not consume as many processing resources sifting through a large amount of information. By the UE (e.g., one or more components of the UE) predicting, during the reference time period and using the genAI model, the resource grant associated with the set of one or more future time resources, the UE may use the resource grant prediction to make more ARD state selections that are more likely to be suitable for the set of one or more future time resources. By the UE communicating with the network node during the set of one or more future time resources, according to the selected ARD state, the UE may conserve power resources and/or increase reliability and/or signal quality.

By the genAI model being trained using the historical communications data, the genAI model may be able to take information into account, when making predictions, that is unavailable to the UE, and thus may be able to predict a future that takes such information into account, thereby providing the ARD components of the UE with information (e.g., which the ARD components may use to select an ARD state) that would otherwise be less accurate (e.g., would not take the information into account). By the genAI model outputting a prediction for each time resource associated with the set of one or more future time resources, the ARD components of the UE may be able to select one or more ARD states corresponding to different periods of time, thereby increasing flexibility and decreasing the likelihood of remaining in an inefficient ARD state and/or necessarily switching ARD states. By the prompt including the indication that the genAI model is to take a hypothetical future scenario into account when predicting whether the resource grant will be communicated, the UE and/or the ARD components of the UE may select an ARD state that may be suitable for various future scenarios and/or the genAI model may be able to predict a more accurate future scenario in which one or more of the hypotheticals occur.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

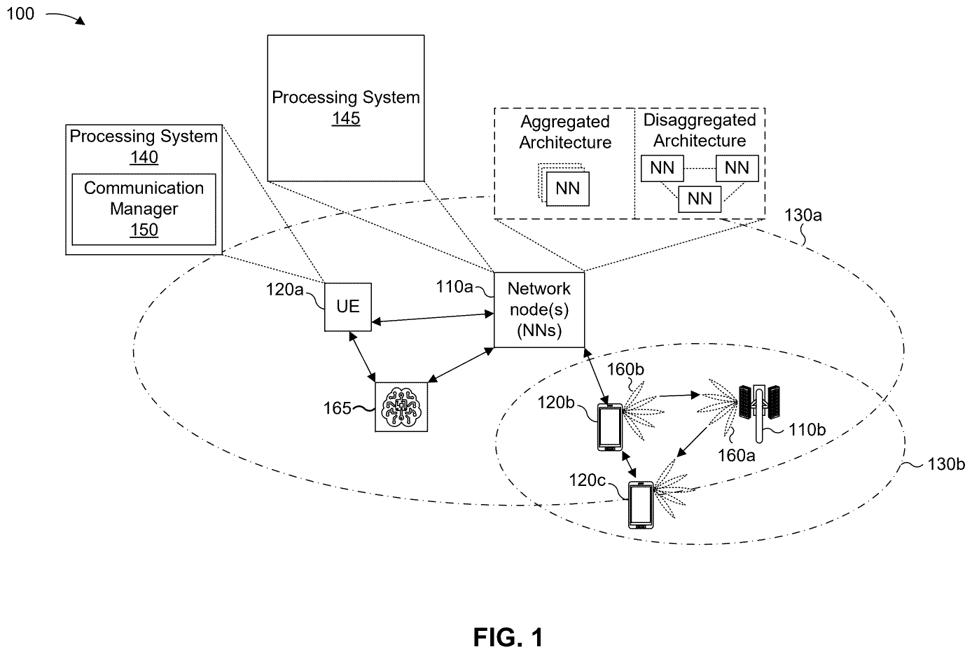

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

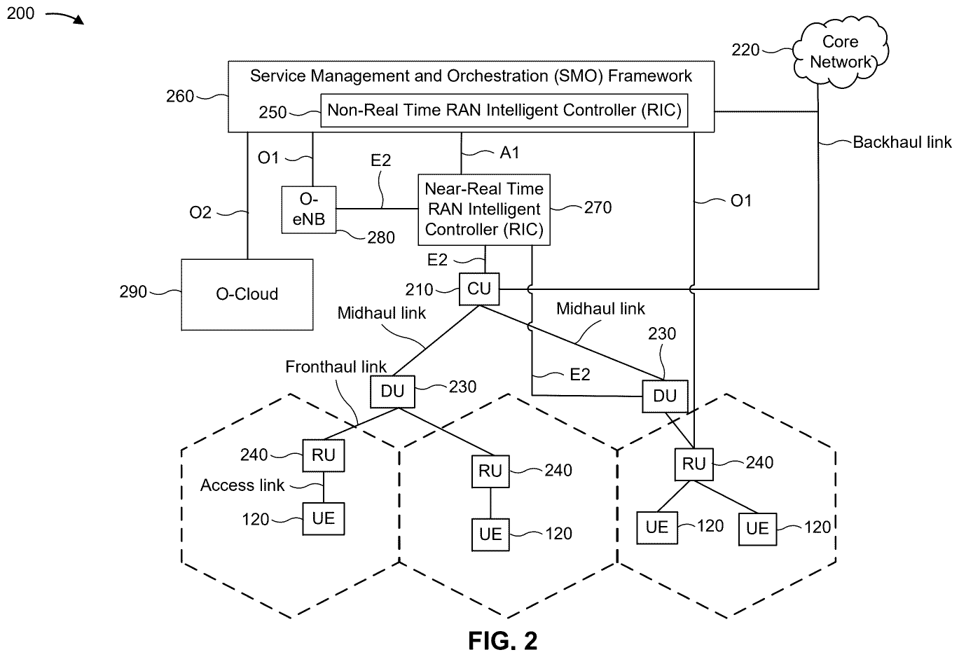

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using a AI program (for example, referred to herein as an “AI model”), such as a program that includes a generative AI model, a machine learning (ML) model and/or an artificial neural network (ANN) model. The AI model may be deployed at one or more devices 165 (for example, a network node 110, UEs 120, and/or a server in communications with the UE). For example, the one or more devices 165 may include a UE 120 (for example, the processing system 140), a network node 110 (for example, the processing system 145), one or more servers capable of running inference programs and/or performing real-time AI model training, and/or one or more components of a cloud computing network, among other examples. In some examples, the AI model (or an instance of the AI model) may be deployed at multiple devices (for example, a first portion of the AI model may be deployed at a UE 120 and a second portion of the AI model may be deployed at a network node 110). In other examples, a first AI model may be deployed at a UE 120 and a second AI model may be deployed at a network node 110. The AI model(s) may be configured to enhance various aspects of the wireless communication network 100. For example, the AI model(s) may be trained to identify patterns or relationships in data corresponding to the wireless communication network 100, a device, and/or an air interface, among other examples. The AI model(s) may support operational decisions relating to one or more aspects associated with wireless communications devices, networks, or services.

An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as the processing system 140 and/or the processing system 145. In some examples, each of the antenna elements of an antenna may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the UE 120 may include a communication manager 150. As described in more detail elsewhere herein, the communication manager 150 may input, during a reference time period, a prompt into a generative artificial intelligence (AI) model, wherein the prompt is associated with a set of one or more past time resources; generate, during the reference time period and using the generative AI model, a sequence of tokens corresponding to a set of one or more future time resources, wherein the sequence of tokens represents one or more predicted communications between the UE and a network node during the set of one or more future time resources; and communicate, with the network node during the set of one or more future time resources, according to an ARD state, wherein the ARD state is selected by the UE according to the one or more predicted communications. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

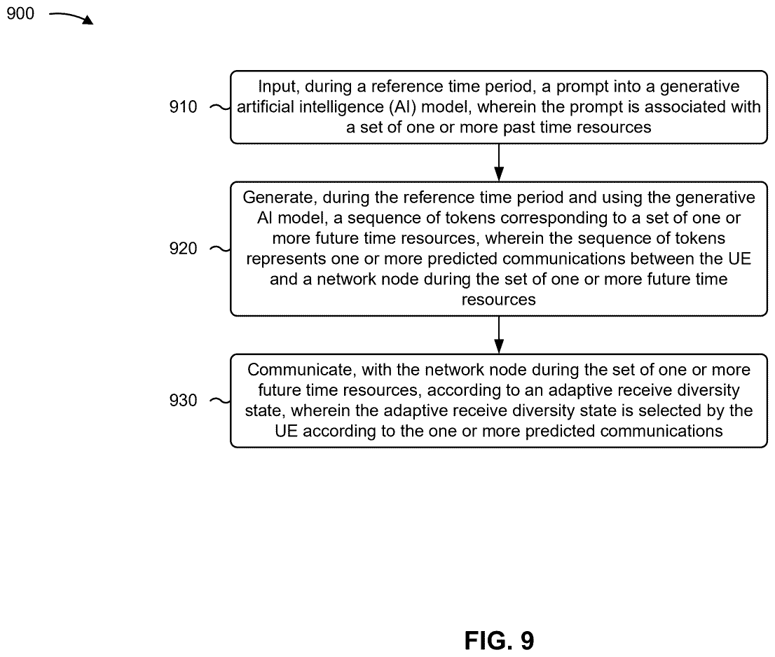

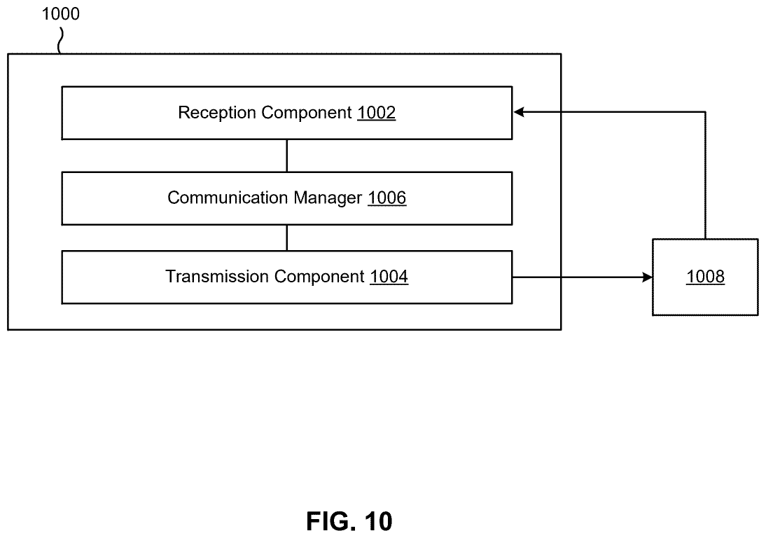

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with adaptive antenna selection using generative artificial intelligence-based link modeling, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for inputting, during a reference time period, a prompt into a genAI model, wherein the prompt is associated with a set of one or more past time resources; means for generating, during the reference time period and using the genAI model, a sequence of tokens corresponding to a set of one or more future time resources, wherein the sequence of tokens represents one or more predicted communications between the UE and a network node during the set of one or more future time resources; and/or means for communicating, with the network node during the set of one or more future time resources, according to an ARD state, wherein the ARD state is selected by the UE according to the one or more predicted communications. The means for the UE to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

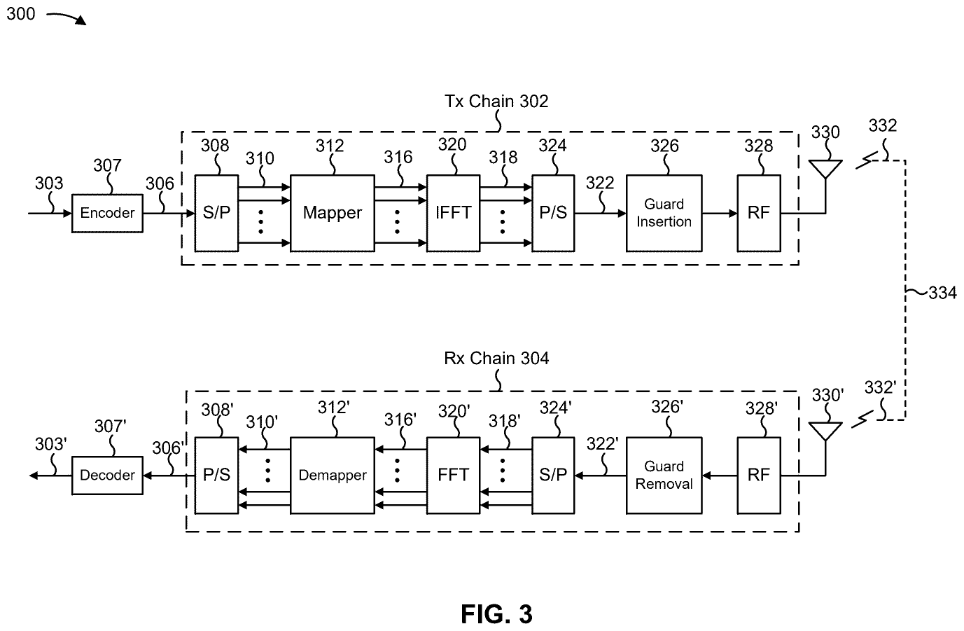

FIG. 3 is a diagram illustrating an example 300 of a transmit (Tx) chain 302 and a receive (Rx) chain 304 of a UE 120, in accordance with the present disclosure. In some aspects, Tx chain 302 may be implemented in UE 120 for transmitting data 306 (e.g., uplink data, an uplink reference signal, and/or uplink control information) to a base station 110 on an uplink channel.

An encoder 307 may alter a signal (e.g., a bitstream) 303 into data 306. Data 306 to be transmitted is provided from encoder 307 as input to a serial-to-parallel (S/P) converter 308. In some aspects, S/P converter 308 may split the transmission data into N parallel data streams 310.

The N parallel data streams 310 may then be provided as input to a mapper 312. Mapper 312 may map the N parallel data streams 310 onto N constellation points. The mapping may be done using a modulation constellation, such as binary phase-shift keying (BPSK), quadrature phase-shift keying (QPSK), 8 phase-shift keying (8PSK), and/or quadrature amplitude modulation (QAM), among other examples. Thus, mapper 312 may output N parallel symbol streams 316, each symbol stream 316 corresponding to one of N orthogonal subcarriers of an inverse fast Fourier transform (IFFT) component 320. The N parallel symbol streams 316 are represented in the frequency domain and may be converted into N parallel time domain sample streams 318 by IFFT component 320.

In some aspects, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of guard insertion component 326 may then be upconverted to a desired transmit frequency band by a radio frequency (RF) front end 328. An antenna 330 may then transmit the resulting signal 332.

In some aspects, Rx chain 304 may utilize OFDM/OFDMA. In some aspects, Rx chain 304 may be implemented in UE 120 for receiving data 306 (e.g., downlink data, a downlink reference signal, and/or downlink control information) from a base station 110 on a downlink channel.

A transmitted signal 332 is shown traveling over a wireless channel 334 from Tx chain 302 to Rx chain 304. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by guard insertion component 326.

The output of guard removal component 326′ may be provided to an S/P converter 324′. The output may include an OFDM/OFDMA symbol stream 322′, and S/P converter 324′ may divide the OFDM/OFDMA symbol stream 322′ into N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by mapper 312, thereby outputting N parallel data streams 310′. A P/S converter 308′ may combine the N parallel data streams 310′ into a single data stream 306′. Ideally, data stream 306′ corresponds to data 306 that was provided as input to Tx chain 302. Data stream 306′ may be decoded into a decoded data stream 303′ by decoder 307′.

In some examples, a UE 120 may be equipped with multiple antennas, which may be used to employ techniques such as transmit diversity, receive diversity, MIMO communications, and/or beamforming. For example, a wireless network may use a MIMO transmission scheme between a transmitting device (e.g., a base station 110) and a receiving device (e.g., a UE 120), where the transmitting device is equipped with multiple antennas and the receiving device is equipped with one or more antennas. For example, the MIMO transmission scheme may employ multipath signal propagation to increase spectral efficiency, increase maximum throughput, and/or increase reliability by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Accordingly, in some communications systems (e.g., NR), an ARD mode may be used to improve a quality or a reliability of a wireless link. For example, a UE 120 may use multiple Rx antennas to receive a common signal transmitted on multiple channels to account for differing levels of fading or interference associated with the multiple channels (e.g., by using switched diversity to select a signal with a best signal-to-noise ratio (SNR) for further processing or using maximum ratio combining to improve the SNR by combining multiple signals). In such cases, using the ARD mode may provide a power gain, a diversity gain, or a spatial nulling gain. However, a number of Rx antennas that are used in the ARD mode may impact power consumption by the UE 120 and/or heating that occurs at the UE 120 (e.g., the UE 120 may consume more power and/or generate more heat when operating in a first ARD mode associated with a first number of Rx antennas versus a second ARD mode associated with a second number of Rx antennas that is less than the first number of Rx antennas). Consequently, because operating in an ARD mode associated with a large number of Rx antennas may consume excess power and/or cause a thermal (e.g., overheating) mitigation condition, a UE 120 may attempt to switch from a first ARD mode to a second ARD mode associated with a fewer number of Rx antennas than the first ARD mode in order to save power and/or reduce heating. Additionally, switching ARD modes may consume energy and time due to tuning and other mode transition operations, and thus, the UE 120 may benefit from avoiding excessive mode switching.

Some ARD algorithms may include and/or be based on rules-based heuristics, and whenever they are based on statistics, some ARD algorithms may be based on historical statistics collected during a time duration (e.g., a time window, timeframe, duration of time, among other examples, that may be predefined according to original equipment manufacturer specifications, wireless communications standards specifications, and/or service provider specifications and/or implementations). Because some ARD algorithms may rely on heuristic rules and/or historical data, the time duration and/or the heuristic rules may be inflexible and thus may not be adaptable to different environmental, network, channel, and/or traffic conditions, and the ARD algorithms may not be configured to generate and/or predict hypothetical futures and/or scenarios and/or may not be configured to adjust the duration of time during which stats are collected for inputting into the ARD algorithms, each of which may limit the effectiveness of ARD algorithms and/or may result in an insufficient quantity of powered receive antennas (e.g., for a particular scenario). As a result, the UE 120 may remain in an ARD mode that uses an inefficient quantity of receive antennas, resulting in decreased quality or reliability, and/or excessive power consumption and/or heating. In some other examples, the UE 120 may switch to an ARD mode that uses an inefficient quantity of receive antennas, consuming additional resources used to switch ARD modes as well as potentially resulting in decreased quality or reliability, and/or excessive power consumption and/or heating. In some other examples, the UE 120 may switch ARD modes for a relatively short duration of time before switching back, thereby consuming additional resources that may not be worth any potential gain in quality, reliability, power consumption, in the relatively short duration of time, given the energy and time consumed during ARD mode switching.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more functions described as being performed by another set of components shown in FIG. 3.

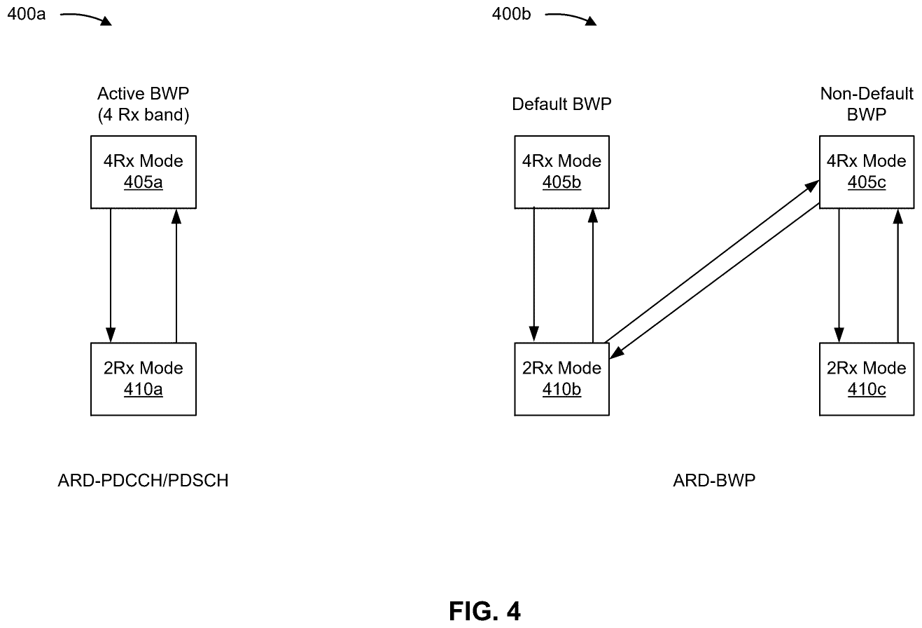

FIG. 4 is a diagram illustrating an example 400a of ARD on a PDCCH/PDSCH and an example 400b of ARD on a BWP, in accordance with the present disclosure.

The example 400a depicts the application of ARD to a PDCCH/PDSCH to improve reception quality by adaptively enabling receive diversity based on signal conditions. In the example 400a, a UE (e.g., UE 120) may be configured for communications via an active BWP that supports up to four receive antennas. In such examples, the UE may switch from a 4Rx Mode 405a (e.g., in which four receive antennas of the UE are activated, powered on, and/or enabled) to a 2Rx Mode 410a (e.g., in which two receive antennas of the UE are activated, powered on, and/or enabled) and/or from the 2Rx Mode 410a to the 4Rx Mode 405a.

The UE may switch from the 4Rx Mode 405a to the 2Rx Mode 410a based on one or more monitored conditions (e.g., down-power conditions). For example, an L1 software module may monitor and or detect that: no downlink grants have been received for a duration of time (e.g., 1s); an RLM SNR is greater than a threshold quantity of decibels (e.g., 9 decibels); an on-demand measurement procedure and/or mode has ended and/or has been deactivated; and/or an RRC reconfiguration process has ended, and may indicate that the UE (e.g., an ARD state machine associated with the UE) is to switch ARD modes. For example, any of the down-power conditions being met may cause the UE to switch from the 4Rx Mode 405a to the 2Rx Mode 410a.

Additionally or alternatively, the UE may switch from the 2Rx Mode 410a to the 4Rx Mode 405a based on one or more other monitored conditions (e.g., up-power conditions). For example, an L1 software module may monitor and or detect that: a downlink grant has been received (e.g., within the duration of time (e.g., 1s)); an RLM SNR is less than a threshold quantity of decibels (e.g., 6 decibels); an on-demand measurement procedure and/or mode has begun and/or has been activated; and/or an RRC reconfiguration process has started and/or been initiated, and may indicate that the UE (e.g., an ARD state machine associated with the UE) is to switch ARD modes. For example, any of the up-power conditions being met may cause the UE to switch from the 2Rx Mode 410a to the 4Rx Mode 405a.

The example 400b depicts the application of ARD to BWPs to improve reception quality by adaptively enabling receive diversity based on signal conditions. In the example 400b, a UE (e.g., UE 120) may be configured for communications via a default BWP that supports up to four receive antennas and/or a non-default BWP that supports up to four receive antennas. In such examples, the UE may switch from a 4Rx Mode 405b (e.g., for the default BWP in which four receive antennas of the UE are activated, powered on, and/or enabled) to a 2Rx Mode 410b (e.g., for the default BWP in which two receive antennas of the UE are activated, powered on, and/or enabled); from the 2Rx Mode 410b to the 4Rx Mode 405b; from the 2Rx Mode 410b to a 4Rx Mode 405c (e.g., for the non-default BWP in which four receive antennas of the UE are activated, powered on, and/or enabled); from the 4Rx Mode 405c to the 2Rx Mode 410b and/or a 2Rx Mode 410c (e.g., for the non-default BWP in which two receive antennas of the UE are activated, powered on, and/or enabled); and/or from the 2Rx Mode 410c to the 4Rx Mode 405c.

The UE may switch from the 4Rx Mode 405b to the 2Rx Mode 410b based on one or more monitored conditions (e.g., default BWP down-power conditions). For example, an L1 software module may monitor and or detect that: an RLM SNR is greater than or equal to a threshold quantity of decibels (e.g., 7); an on-demand measurement procedure and/or mode has ended and/or has been deactivated; and/or an RRC reconfiguration process has ended, and may indicate that the UE (e.g., an ARD state machine associated with the UE) is to switch ARD modes. For example, any of the default BWP down-power conditions being met may cause the UE to switch from the 4Rx Mode 405b to the 2Rx Mode 410b.

Additionally or alternatively, the UE may switch from the 2Rx Mode 410b to the 4Rx Mode 405b based on one or more other monitored conditions (e.g., default BWP up-power conditions). For example, an L1 software module may monitor and or detect that: an RLM SNR is less than a threshold quantity of decibels (e.g., 6 decibels); an on-demand measurement procedure and/or mode has begun and/or has been activated; and/or an RRC reconfiguration process has started and/or been initiated, and may indicate that the UE (e.g., an ARD state machine associated with the UE) is to switch ARD modes. For example, any of the default BWP up-power conditions being met may cause the UE to switch from the 2Rx Mode 410b to the 4Rx Mode 405b.

Additionally or alternatively, the UE may switch from the 2Rx Mode 410b to the 4Rx Mode 405c based on one or more other monitored conditions (e.g., BWP switching up-power conditions). For example, a general manager layer of the UE and/or a firmware layer of the UE may receive an indication to switch to communicating via the non-default BWP. For example, receiving a DCI BWP switch indication (e.g., switch to non-default BWP indication) may cause the UE to switch from the 2Rx Mode 410b to the 4Rx Mode 405c.

Additionally or alternatively, the UE may switch from the 4Rx Mode 405c to the 2Rx Mode 410b based on one or more other monitored conditions (e.g., BWP switching down-power conditions). For example, an L1 software module of the UE may receive an indication to switch to communicating via the default BWP and/or may identify that an inactivity time has expired (e.g., the UE may be inactivated and/or may not receive a downlink communication for a period of time). For example, receiving a DCI BWP switch indication (e.g., switch to default BWP indication) may cause the UE to switch from the 4Rx Mode 405c to the 2Rx Mode 405c. In some examples, an inactivity timer expiration may trigger the UE to switch from the 4Rx Mode 405c to the 2Rx Mode 405c.

The UE may switch from the 4Rx Mode 405c to the 2Rx Mode 410c based on one or more monitored conditions (e.g., non-default BWP down-power conditions). For example, an L1 software module may monitor and or detect that: no downlink grants have been received for a duration of time (e.g., 1s); an RLM SNR is greater than or equal to a threshold quantity of decibels (e.g., 7 decibels); an on-demand measurement procedure and/or mode has ended and/or has been deactivated; and/or an RRC reconfiguration process has ended, and may indicate that the UE (e.g., an ARD state machine associated with the UE) is to switch ARD modes. For example, any of the non-default BWP down-power conditions being met may cause the UE to switch from the 4Rx Mode 405c to the 2Rx Mode 410c.

Additionally or alternatively, the UE may switch from the 2Rx Mode 410c to the 4Rx Mode 405c based on one or more other monitored conditions (e.g., non-default BWP up-power conditions). For example, an L1 software module may monitor and or detect that: a downlink grant has been received (e.g., within the duration of time (e.g., 1s)); an RLM SNR is less than a threshold quantity of decibels (e.g., 6 decibels); an on-demand measurement procedure and/or mode has begun and/or has been activated; and/or an RRC reconfiguration process has started and/or been initiated, and may indicate that the UE (e.g., an ARD state machine associated with the UE) is to switch ARD modes. For example, any of the non-default BWP up-power conditions being met may cause the UE to switch from the 2Rx Mode 410c to the 4Rx Mode 405c.

As indicated above, FIG. 4 is provided as an example. Other examples may differ from what is described with respect to FIG. 4.

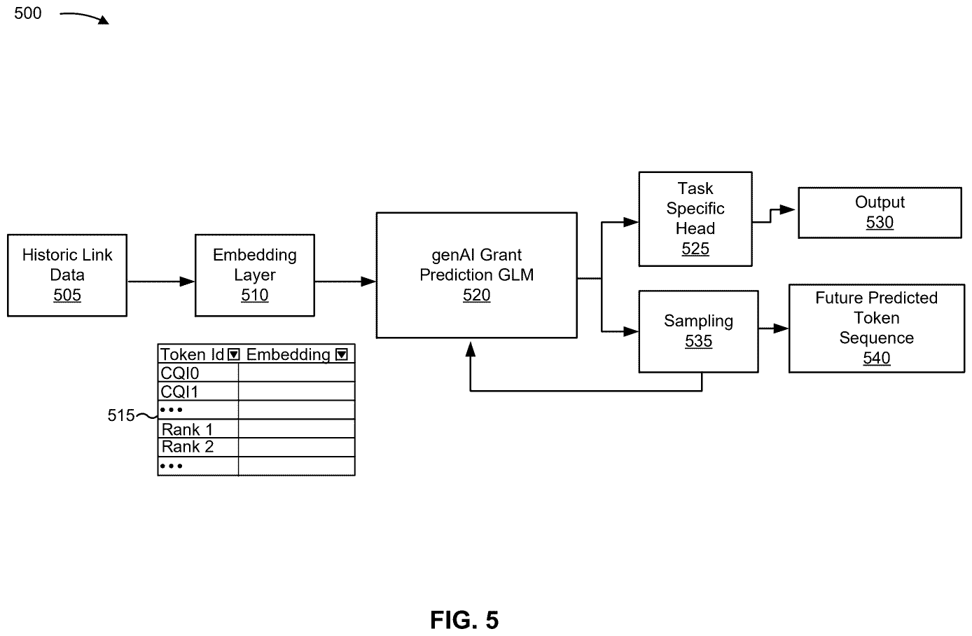

FIG. 5 is a diagram illustrating an example 500 of a generative artificial intelligence (AI) foundational model including a grant prediction generative link model, in accordance with the present disclosure.

The example 500 illustrates operations associated with a foundational model (e.g., a deep learning model that is trained on a large quantity of data from different contexts and may be adapted and/or finetuned to different scenarios and/or contexts by limiting training data and/or data output) including a generative AI grant prediction link model 520 that includes a large learning model (e.g., a foundational model trained on tokens (e.g., elements corresponding to a single value and/or field of a UE-network node interaction) derived from natural language datasets) trained on language that models wireless communications protocols (e.g., a wireless communications language).

Historic link data 505 may be input into an embedding layer 510 associated with the generative AI grant prediction link model 520. For example, the historic link data 505 may include data associated with past link activity and/or data and/or a prompt associated with a hypothetical future of the communications link. The embedding layer 510 may convert discrete categorical data, for example, including the historic link data 505, into dense, continuous vectors of a fixed size. Historical link data 505 may include one or more configurations, and/or a hypothetical future scenario input using a wireless communications language.

The embedding table 515 illustrates that these vectors, known as embeddings, may capture similarities and patterns in the data, enabling the generative AI grant prediction link model 520 to process categorical inputs in a way that preserves relationships and contexts between categorical inputs.

The generative AI grant prediction link model 520 may integrate past communication link activity (e.g., data associated with past communications via a link between the UE and the network node), such as downlink rank, MCS, a quantity of resource elements granted by a downlink resource grant, a total quantity of resource elements granted by each downlink resource grant communicated via the link, HARQ ACK/NACK feedback, and/or uplink CSF reports to predict future link activity, such as a task-specific output of interest 530, which may include a direct answer to the prompt and/or a contextually relevant (e.g., to the prompt) output, and/or to predict a future predicted token sequence 540, which may include individual tokens that the model predicts at each step in the generation process. For example, a task-specific head(s) 525 associated with the generative AI grant prediction link model 520 may be input information from the generative AI grant prediction link model 520 and may output the output of interest 530. Task-specific head(s) 525 and/or neural networks may include a layer (e.g., such as a multilayer perceptron) of the foundational model to predict a quantity of interest other than the “next token” (e.g., which is the default target). In some aspects, the output 530 may include a task-specific output. For example, the task specific head(s) 525 may include one or more task specific heads that each prioritize a different parameter (e.g., such as throughput and/or power) and different task specific head(s) 525 may generate various outputs 530 (e.g., that prioritize various parameters). For example, a power task specific head may generate an output that prioritizes power conservation (e.g., at the cost of throughout and/or another parameter), and a throughput task specific head may generate an output that prioritizes throughput (e.g., at the cost of power conservation).

In some other examples, sampling 535 may generate a token sequence 540 and the UE may derive additional outputs (e.g., outputs that prioritize various outputs) from the token sequence 540 and may input the additional outputs in an ARD state machine to obtain an ARD selection that prioritizes various parameters.

Sampling 535 may include selecting or generating specific outputs from a probability distribution over possible outputs of the future predicted token sequence 540, which may be input back into the generative AI grant prediction link model 520 to influence future predictions. As a non-limiting example, sampling 535 may output a sequence that may enable the UE to calculate an expected BLER and/an expected granted rank of future communications.

In some examples, the generative AI grant prediction link model 520 may integrate past communication link activity with a hypothetical future (e.g., input as a part of the prompt and/or along with the past link activity) to predict future link activity. In some examples, the future link activity may be predicted on a time resource (e.g., slot) by time resource basis. In some examples, the generative AI grant prediction link model 520 may use one or more preceding predictions and/or the originally input prompt each time that a future prediction is output, which may be referred to as autoregressive prediction.

When the generative AI grant prediction link model 520 predicts a grant, rank, MCS, and/or grant size may be predicted by the generative AI grant prediction link model 520 as well.

As indicated above, FIG. 5 is provided as an example. Other examples may differ from what is described with respect to FIG. 5.

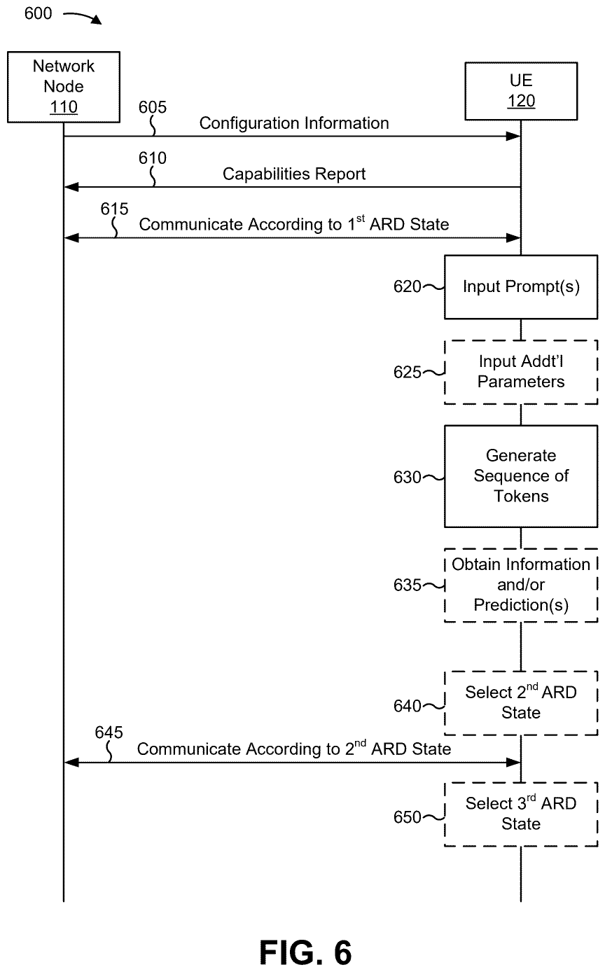

FIG. 6 is a diagram of an example 600 associated with adaptive antenna selection using generative artificial intelligence-based link modeling, in accordance with the present disclosure. As shown in FIG. 6, a network node 110 (e.g., network node 110 described in connection with FIG. 1, a CU, a DU, and/or an RU) may communicate with a UE 120 (e.g., UE 120 described in connection with FIG. 1). In some aspects, the network node 110 and the UE 120 may be part of a wireless network (e.g., wireless network 100). The UE 120 and the network node 110 may have established a wireless connection prior to operations shown in FIG. 6.

As shown by reference number 605, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may indicate a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE 120 is to perform link modeling using a genAI model. In some aspects, the configuration information may indicate a particular genAI model for the UE to use to perform link modeling. In some other aspects, the configuration information may indicate one or more parameters associated with the genAI model. In some aspects, the genAI model may be trained using data not readily available to the UE 120 (e.g., data associated with operations at the network node 110). In some aspects, the genAI model may be trained using historical communications data associated with communications between the network node 110 and the UE 120. In some aspects, the genAI model may be trained using data associated with past communications between the UE 120 and the network node 110. In such aspects, the data may be mapped to one or more conditions associated with the past communications. In some aspects, the genAI model may be trained using historical communications data associated with network node traffic loads. In some aspects, the genAI model may be trained using historical communications data associated with network traffic conditions. In some aspects, the genAI model may be trained using historical communications data associated with traffic class. In some aspects, the genAI model may be trained using historical communications data associated with outer loop operations. In some aspects, the genAI model may be trained using historical communications data associated with a proportionally fair parameter associated with the network node 110.

The UE 120 may configure itself based at least in part on the configuration information. In some aspects, the UE 120 may be configured to perform one or more operations described herein based at least in part on the configuration information.

As shown by reference number 610, the UE 120 may transmit, and the network node 110 may receive, a capabilities report. The capabilities report may indicate whether the UE 120 supports a feature and/or one or more parameters related to the feature. For example, the capability information may indicate a capability and/or parameter for inputting and/or obtaining information for the genAI model. As another example, the capabilities report may indicate a capability and/or parameter for ARD-based decision-making using outputs from the genAI model. One or more operations described herein may be based on capability information of the capabilities report. For example, the UE 120 may perform a communication in accordance with the capability information, and/or may receive configuration information that is in accordance with the capability information. In some aspects, the capabilities report may indicate UE 120 support for communications via one or more frequency band combinations, multi-BWP communications, ARD operations, genAI-based ARD operations, one or more MIMO configurations, and/or supplementary uplink communications, among other examples.

In some aspects, the configuration information described in connection with reference number 605 and/or the capabilities report described in connection with reference number 610 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 615, the network node 110 and the UE 120 may communicate with each other according to a first ARD state. For example, the first ARD state may include a quantity of powered antennas (e.g., a connected discontinuous reception mode, 1, Rx, . . . 8 Rx mode, etc.) selected according to one or more ARD techniques and/or an ARD state machine. In some examples, the ARD state may include a mode of communication via a quantity of receive antennas in which ARD is not yet activated and/or in use by the UE 120.

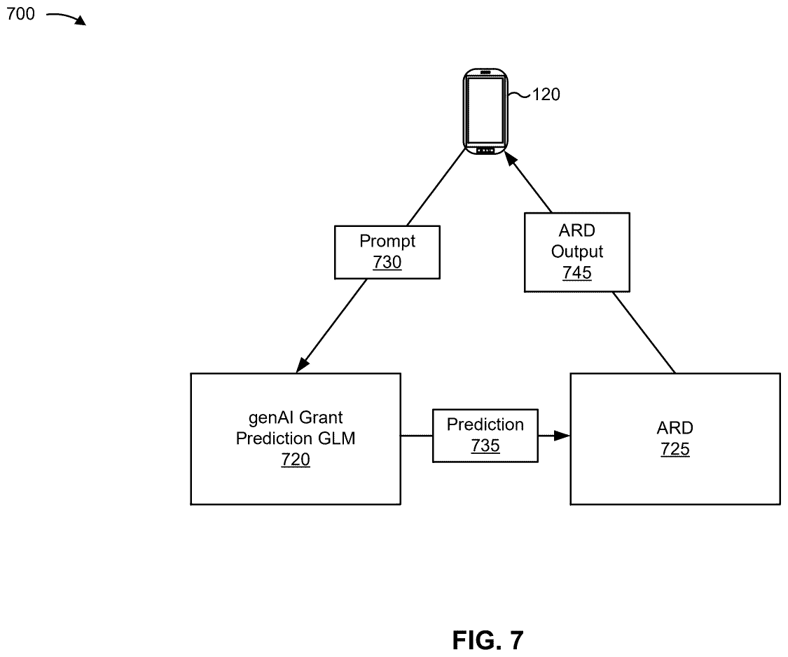

As shown by reference number 620, the UE 120 may input one or more prompts into the genAI model. For example, the UE 120 may input, during a reference time period, a prompt into a genAI model. In some aspects, the prompt may be associated with a set of one or more past time resources (e.g., frames, subframes, slots, subslots, or the like), settings (e.g., of the UE 120 and/or the network node 110), and/or configurations (e.g., of the UE 120 and/or the network node 110). In some aspects, the genAI model may include and/or perform operations performed by the generative AI grant prediction link model 520 described in connection with FIG. 5 and/or the generative AI grant prediction link model 720 described below in connection with FIG. 7. In some aspects, the prompt may indicate that the genAI model is to take a hypothetical future scenario into account when predicting whether the resource grant will be communicated and/or when generating the sequence of tokens. For example, the prompt may query the genAI model for a future prediction associated with future scenarios that the UE 120 may define based on hypothetical channel conditions, hypothetical network conditions, hypothetical traffic conditions, mobility scenarios, and/or location scenarios, among other examples. In some aspects, the prompt may indicate a quantity of time resources in the set of one or more past time resources, and/or the information associated with the set of one or more past time resources. In some aspects, the prompt may indicate past communications and/or a setting and/or a hypothetical future.

As shown by reference number 625, in some aspects, the UE 120 may input one or more additional parameters into the genAI model. For example, the UE 120 may input, into the genAI model, information associated with a ser of one or more past time resources, and/or a quantity of past time resources in the set of one or more past time resources. In some aspects, the reference time period may occur after the set of one or more past time resources and/or before a set of one or more future time resources. The set of future time resources may include an initial time resource that is separated from an ending time resource of the reference time period by a variable quantity of time slots, and/or a variable quantity of time resources subsequent to the initial time resource.

As shown by reference number 630, the UE 120, and/or the genAI model associated with the UE 120, may generate a sequence of tokens. For example, the UE 120 may generate during the reference time period and using the genAI model, a sequence of tokens corresponding to a set of one or more future time resources. In such examples, the sequence of tokens may represent and/or correspond to one or more predicted communications between the UE 120 and the network node 110 during the set of one or more future time resources.

In some aspects, the one or more predicted communications may indicate or include whether each of the one or more predicted communications will be communicated during the set of one or more future time resources, a future time resource during which at least one of the one or more predicted communications will be communicated, a downlink rank associated with at least one of the one or more predicted communications, a modulation and coding scheme associated with at least one of the one or more predicted communications, a time of arrival associated with at least one of the one or more predicted communications, wherein the set of one or more future time resources includes the time of arrival, whether at least one of the one or more predicted communications will be successfully decoded, and/or a quantity of resource elements associated with at least one of the one or more predicted communications.

In some aspects, the UE 120, and/or the genAI model associated with the UE 120, may generate an additional sequence of tokens corresponding to the set of one or more future time resources. In such aspects, the additional sequence of tokens represents a set of one or more parameters associated with the predicted communications.

In some aspects, the UE 120 may generate the sequence of tokens in accordance with information associated with the set of one or more past time resources. In some aspects, the set of one or more past time resources includes a time resource that is separated from an initial time resource of the reference time period by a variable quantity of time slots, and/or a variable quantity of time resources relative to the time resource. In some aspects, one or more past resource grants communicated during the set of one or more past time resources, one of more spectral efficiency values associated with the one or more past resource grants, at least one downlink rank associated with communications during the set of one or more past time resources, at least one modulation and coding scheme associated with communications during the set of one or more past time resources, a quantity of resource elements granted by each of the one or more past resource grants communicated during the set of one or more past time resources, a total quantity of resource elements granted by the one or more past resource grants communicated during the set of one or more past time resources, hybrid automatic repeat request feedback associated with communications during the set of one or more past time resources, one or more channel state feedback reports associated with communications during the set of one or more past time resources, channel quality information associated with communications during the set of one or more past time resources, and/or traffic load information associated with communications during the set of one or more past time resources.

In some aspects, the UE 120 may generate, in accordance with the prompt, a first set of one or more tokens corresponding to a first time resource of the set of one or more future time resources. In such aspects, the first set of one or more tokens may represent one or more communications that are predicted to occur during the first time resource. Additionally, the UE 120 may generate, in accordance with the prompt and the first set of one or more tokens, a second set of one or more tokens corresponding to a second time resource of the set of one or more time resources. In such aspects, the second set of one or more tokens may represent one or more communications that are predicted to occur during the second time resource in accordance with the one or more communications that are predicted to occur during the first time resource.

In some aspects, the UE 120 may predict one or more parameters associated with a future resource grant. For example, the UE 120 and/or the UE 120 via the genAI model may predict a set of one or more parameters associated with the resource grant. In some aspects, the genAI model may be used by the UE 120 to predict a future resource grant arrival time, a granted rank, and/or corresponding bit loss error rate (BLER) by inputting a prompt (e.g., described in connection with reference number 620) that queries the genAI model, such as “what is the granted rank of the next resource grant and the associated BLER?”

As shown by reference number 635, in some aspects, the UE 120 may obtain, from the genAI model, information and/or one or more predictions. For example, in some aspects, the prompt may query and/or request a set of information from the genAI model according to a task-specific head of the genAI model that is associated with predictive link modeling. In such aspects, the UE 120 may obtain a set of information from the genAI model in association with generating the sequence of tokens, where the set of information includes the one or more predicted communications.

In some aspects, the UE 120 may obtain, and/or the genAI model may output, a prediction for each time resource associated with the set of one or more future time resources. In such aspects, each prediction, after an initial prediction, may be generated in association with the information associated with the adjustable set of one or more past time resources and a prediction associated with a time resource immediately preceding the time resource for which the prediction is obtained. For example, the genAI model may perform autoregressive prediction.

In some aspects, the output may indicate an ARD state and/or a quantity of receive antenna to power. For example, based on whether the UE wants to prioritize throughput and/or power the genAI model may use different task specific heads (e.g., task specific head(s) 525 described in connection with FIG. 5) to obtain various outputs (e.g., that prioritize various parameters).

In some aspects, the UE 120, and/or the genAI model associated with the UE 120, may obtain a prediction for each future time resource. For example, a prediction for each time resource of the set of one or more future time resources. In such aspects, each prediction, after an initial prediction, may be generated in association with information corresponding to the set of one or more past time resources and a prediction associated with one or more future time resources preceding the time resource for which the prediction is obtained predict a future resource grant.

In some aspects, the UE 120 may predict, during the reference time period and using the genAI model, a resource grant associated with a set of one or more future time resources in accordance with information associated with an adjustable set of one or more past time resources. In some aspects, the genAI model may output a prediction for each time resource associated with the set of one or more future time resources.

In some aspects, the set of one or more future time resources may include a quantity of time resources subsequent to the reference time period. In some aspects, the adjustable set of one or more past time resources may include a quantity of time resources selected and/or input by the UE 120 during which historic data that occurred during the adjustable set of one or more past time resources is taken into account by the genAI model for predicting the future resource grant. In some aspects, the adjustable set of one or more past time resources may include a different quantity of time resources for one prompt than for another prompt. In some aspects, a prompt may include and/or indicate the quantity of time resources in the adjustable set of one or more past time resources. In some aspects, the prompt may include and/or indicate the quantity of time resources in the set of one or more future time resources. For example, the prompt may query whether a grant will be received during an indicated quantity of future time resources and/or may query when a future grant will next be received.

In some aspects, the information associated with the adjustable set of one or more past time resources may include at least one downlink rank associated with communications during the adjustable set of one or more past time resources. For example, historic data may include past downlink ranks of past resource grants. In some aspects, the information associated with the adjustable set of one or more past time resources may include at least one MCS associated with communications during the adjustable set of one or more past time resources. In some aspects, the information associated with the adjustable set of one or more past time resources may include a quantity of resource elements granted by a past resource grant communicated during the adjustable set of one or more past time resources. In some aspects, the information associated with the adjustable set of one or more past time resources may include a total quantity of resource elements granted by each past resource grant communicated during the adjustable set of one or more past time resources. In some aspects, the information associated with the adjustable set of one or more past time resources may include HARQ ACK/NACK feedback associated with communications during the adjustable set of one or more past time resources. In some aspects, the information associated with the adjustable set of one or more past time resources may include one or more CSF reports associated with communications during the adjustable set of one or more past time resources. In some aspects, the information associated with the adjustable set of one or more past time resources may include CQI associated with communications during the adjustable set of one or more past time resources. In some aspects, the information associated with the adjustable set of one or more past time resources may include traffic load information associated with communications during the adjustable set of one or more past time resources.

In some aspects, predicting the resource grant may include predicting whether the resource grant will be communicated during the set of one or more future time resources. In some aspects, predicting the resource grant may include predicting a downlink rank associated with the resource grant. In some aspects, predicting the resource grant may include predicting an MCS associated with the resource grant. In some aspects, predicting the resource grant may include predicting a time of arrival of the resource grant. In such aspects, the set of one or more future time resources may include the time of arrival. In some aspects, predicting the resource grant may include predicting a BLER associated with the resource grant. In some aspects, predicting the resource grant may include predicting a quantity of resource elements associated with the resource grant.

As shown by reference number 640, in some aspects, the UE 120, and/or an ARD component associated with the UE 120, may select a second ARD state. For example, the UE 120 may select the second ARD state according to one or more predicted parameters of the resource grant (e.g., described in connection with reference number 630). In some aspects, the second ARD state may be selected by ARD components, algorithms, and/or an ARD state machine associated with the UE 120. For example, the ARD components, algorithms, and/or an ARD state machine may obtain predictions and/or any generated information from the genAI model and may output a suggested ARD state based on the predictions.

In some aspects, the UE 120 may select a quantity of active receive antennas that correspond to the second ARD state according to the one or more predicted communications. A quantity of powered receive ante4nnas corresponding to the second ARD state may be more or less than a quantity of powered receive antennas corresponding to the first ARD state.

As shown by reference number 645, the network node 110 and the UE 120 may communicate with each other according to the second ARD state. For example, the second ARD state may include a quantity of powered antennas (e.g., 0Rx mode, 2Rx mode, 4Rx mode, 6Rx mode, 8 Rx mode) that is different from that of the first ARD state. In some aspects, the second ARD state may include a quantity of powered antennas that is the same as that of the first ARD state. In some aspects, the second ARD state may include any activated ARD state, and the first ARD state may include a deactivated ARD communication mode. That is, selecting the second ARD state, described in connection with reference number 640, may include determining to activate ARD operations at the UE 120 and/or to enter an initial ARD state.

In some aspects, the UE 120 may communicate with the network node 110 during the set of one or more future time resources, according to an ARD state. In such aspects, the ARD state may be selected by the UE 120 according to the one or more predicted communications.

In some aspects, communicating according to the second ARD state may include the network node 110 transmitting, and the UE 120 receiving, during the set of one or more future time resources, one or more communications. For example, the network node 110 may identify and/or obtain data and/or control information to be communicated with the UE 120 and may transmit the one or more communications. In some aspects, the communications may be and/or may be associated with aspects of the predicted one or more future communications.

As shown by reference number 650, the UE 120 may select a third ARD state. For example, the UE 120 may be free to switch ARD states and may switch to a third ARD state, a fourth ARD state, etc., based on other predictions output by the genAI model, and/or other factors.

As indicated above, FIG. 6 is provided as an example. Other examples may differ from what is described with respect to FIG. 6.

FIG. 7 is a diagram illustrating an example 700 of ARD with genAI-based link modeling, in accordance with the present disclosure. As shown in FIG. 7, a UE 120 may communicate with an ARD component 725, and/or a generative AI grant prediction link model 720, each of which may be a component of the UE 120 and/or may be physically separate from the UE 120 (e.g., may be stored via cloud storage and/or one or more network components).

The UE 120 may input a prompt 730 into the generative AI grant prediction link model 720. The generative AI grant prediction link model 720 may obtain the prompt 730 and may output one or more predictions associated with future communications. For example, the generative AI grant prediction link model 720 may predict whether a resource grant will be transmitted to the UE 120 during a future period of time (e.g., specified by the prompt) and/or may predict a time of arrival of a next occurring (e.g., most likely to occur next) resource grant. The generative AI grant prediction link model 720 may, additionally or alternatively, predict one or more parameters associated with the future communications as described with reference to FIG. 6.

For example, the generative AI grant prediction link model 720 may be configured to simulate a realistic future given the recent past (e.g., an adaptable set of one or more past time resources). In some aspects, the generative AI grant prediction link model 720 may be configured to concatenate the recent past with a hypothetical future and obtain statistics and/or data associated with a subsequent outcome/event. In some aspects, the generative AI grant prediction link model 720 may make predictions on a token-by-token, and/or a slot-by-slot, approach. In such aspects, future parameters, such as resource grant arrival time, granted rank, and/or BLER may be calculated by generating a set of possible futures and obtaining a set of statistics to determine a most likely future scenario. As a result, the UE 120 may use the generative AI grant prediction link model 720 to predict a most likely future resource grant arrival time, associated rank, and/or corresponding BLER. Such results may be obtained by the prompt 730 including a query such as, “what is the granted rank of a next resource grant and the associated BLER, for example.

The generative AI grant prediction link model 720 may output predictions to the ARD component 725. The ARD component 725 may use (e.g., take into account) and/or input the predictions into one or more ARD algorithms for selecting an ARD state of the UE 120. For example, the ARD component 725 may use the predictions to select a next ARD state for the UE 120, which may include remaining in a current ARD state, switching to a lower ARD state, and/or switching to a higher ARD state, in accordance with the future predictions.

The prediction 735 may include the generative AI grant prediction link model 720 outputs as input to the ARD component 725. For example, based on a prognosticated BLER, rank indication, and/or other state information (e.g., such as an L1 software module state), the ARD component 725 may select the 2Rx state (e.g., described with reference to FIG. 4) when a prognosticated BLER is predicted to be relatively small. In some other aspects, when a higher rank than a current rank is predicted, and the ARD state includes an ARD-PDSCH state, the ARD component 725 may select a relatively high ARD state (e.g., 4Rx, 6Rx, and/or 8Rx). In some other aspects, when no grant is expected (e.g., during a quantity of future slots), the ARD component 725 may select a relatively low ARD state (e.g., 0Rx, 1Rx, 2Rx). In some aspects, predicting any upcoming grants may increase a time spent by the UE 120 in the 2Rx state without significant impact on downlink throughput and/or BLER, thereby conserving more power than ARD without link modeling/prediction.

The ARD component 725 may output ARD output 745 to the UE 120, which may prompt the UE 120 to utilize the selected next ARD state.

As indicated above, FIG. 7 is provided as an example. Other examples may differ from what is described with respect to FIG. 7.

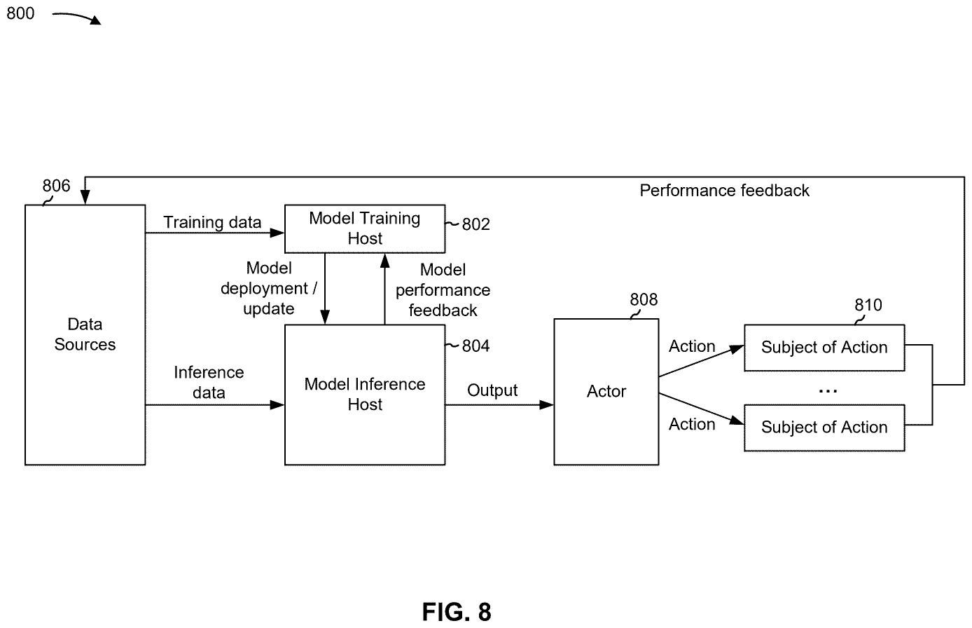

FIG. 8 is a diagram illustrating an example architecture 800 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI and/or machine learning and the associated functional framework (e.g., the AI functionality and/or the input/output of the component for AI enabled optimization) have been utilized or studied to identify the benefits of AI-enabled RAN through possible use cases (e.g., beam management, energy saving, load balancing, mobility management, and/or coverage optimization, among other examples). In one example, as shown by the architecture 800, a functional framework for RAN intelligence may include multiple logical entities, such as a model training host 802, a model inference host 804, data sources 806, and an actor 808.

The model inference host 804 may be configured to run a genAI model based on inference data provided by the data sources 806, and the model inference host 804 may produce an output (e.g., a prediction) with the inference data input to the actor 808. The actor 808 may be an element or an entity of a core network or a RAN. For example, the actor 808 may be a UE, a network node, a base station (e.g., a gNB), a CU, a DU, and/or an RU, among other examples. In addition, the actor 808 may also depend on the type of tasks performed by the model inference host 804, the type of inference data provided to the model inference host 804, and/or the type of output produced by the model inference host 804. For example, if the output from the model inference host 804 is associated with beam management, then the actor 808 may be a UE, a DU or an RU. In other examples, if the output from the model inference host 804 is associated with Tx/Rx scheduling, then the actor 808 may be a CU or a DU.

After the actor 808 receives an output from the model inference host 804, the actor 808 may determine whether to act based on the output. For example, if the actor 808 is a DU or an RU and the output from the model inference host 804 is associated with beam management, the actor 808 may determine whether to change/modify a Tx/Rx beam based on the output. If the actor 808 determines to act based on the output, the actor 808 may indicate the action to at least one subject of action 810. For example, if the actor 808 determines to change/modify a Tx/Rx beam for a communication between the actor 808 and the subject of action 810 (e.g., a UE 120), then the actor 808 may transmit a beam (re-)configuration or a beam switching indication to the subject of action 810. The actor 808 may modify its Tx/Rx beam based on the beam (re-)configuration, such as switching to a new Tx/Rx beam or applying different parameters for a Tx/Rx beam, among other examples. As another example, the actor 808 may be a UE and the output from the model inference host 804 may be associated with beam management. For example, the output may be one or more predicted measurement values for one or more beams. The actor 808 (e.g., a UE) may determine that a measurement report (e.g., a Layer 1 (L1) RSRP report) is to be transmitted to a network node 110.

The data sources 806 may also be configured for collecting data that is used as training data for training an ML model or as inference data for feeding an ML model inference operation. For example, the data sources 806 may collect data from one or more core network and/or RAN entities, which may include the subject of action 810, and provide the collected data to the model training host 802 for ML model training.

For example, after a subject of action 810 (e.g., a UE 120) receives a beam configuration from the actor 808, the subject of action 810 may provide performance feedback associated with the beam configuration to the data sources 806, where the performance feedback may be used by the model training host 802 for monitoring or evaluating the ML model performance, such as whether the output (e.g., prediction) provided to the actor 808 is accurate. In some examples, if the output provided by the actor 808 is inaccurate (or the accuracy is below an accuracy threshold), then the model training host 802 may determine to modify or retrain the ML model used by the model inference host, such as via an ML model deployment/update.

The output may include information which the actor 808 may use to inform one or more ARD processes for link-modeling-based ARD. In some aspects, the actor 808 may include one or more ARD components of a UE. In such examples, the actor 808 may receive the output and may perform one or more actions, such as switching ARD states and/or refraining from switching ARD states, based on the output. In some aspects, the output may include a prediction associated with one or more future resource grants. For example, the output may include whether one or more future resource grants will be communicated during a set of one or more future time resources; a downlink rank corresponding to each of the one or more future resource grants; an MCS corresponding to each of the one or more future resource grants; a time of arrival corresponding to each of the one or more future resource grants; a BLER corresponding to each of the one or more future resource grants; and/or a quantity of resource elements corresponding to each of the one or more future resource grants.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with adaptive antenna selection using generative artificial intelligence-based link modeling.

As shown in FIG. 9, in some aspects, process 900 may include inputting, during a reference time period, a prompt into a genAI model, wherein the prompt is associated with a set of one or more past time resources (block 910). For example, the UE (e.g., using communication manager 1006, depicted in FIG. 10) may input, during a reference time period, a prompt into a genAI model, wherein the prompt is associated with a set of one or more past time resources, as described above.

As further shown in FIG. 9, in some aspects, process 900 may include generating, during the reference time period and using the genAI model, a sequence of tokens corresponding to a set of one or more future time resources, wherein the sequence of tokens represents one or more predicted communications between the UE and a network node during the set of one or more future time resources (block 920). For example, the UE (e.g., using communication manager 1006, depicted in FIG. 10) may generate, during the reference time period and using the generative AI model, a sequence of tokens corresponding to a set of one or more future time resources, wherein the sequence of tokens represents one or more predicted communications between the UE and a network node during the set of one or more future time resources, as described above.

As further shown in FIG. 9, in some aspects, process 900 may include communicating, with the network node during the set of one or more future time resources, according to an ARD state, wherein the ARD state is selected by the UE according to the one or more predicted communications (block 930). For example, the UE (e.g., using reception component 1002, transmission component 1004, and/or communication manager 1006, depicted in FIG. 10) may communicate, with the network node during the set of one or more future time resources, according to an ARD state, wherein the ARD state is selected by the UE according to the one or more predicted communications, as described above.

Process 900 may include additional aspects, such as any single aspect or any combination of aspects described below and/or in connection with one or more other processes described elsewhere herein.

In a first aspect, generating the sequence of tokens comprises generating an additional sequence of tokens corresponding to the set of one or more future time resources, wherein the additional sequence of tokens represents a set of one or more parameters associated with the predicted communications.

In a second aspect, alone or in combination with the first aspect, the set of one or more future time resources include an initial time resource that is separated from an ending time resource of the reference time period by a variable quantity of time slots, and a variable quantity of time resources subsequent to the initial time resource.

In a third aspect, alone or in combination with one or more of the first and second aspects, generating the sequence of tokens comprises generating the sequence of tokens in accordance with information associated with a set of one or more past time resources.

In a fourth aspect, alone or in combination with one or more of the first through third aspects, the set of one or more past time resources include a time resource that is separated from an initial time resource of the reference time period by a variable quantity of time slots, and a variable quantity of time resources relative to the time resource.

In a fifth aspect, alone or in combination with one or more of the first through fourth aspects, the information associated with the set of one or more past time resources includes one or more of one or more past resource grants communicated during the set of one or more past time resources, one of more spectral efficiency values associated with the one or more past resource grants, at least one downlink rank associated with communications during the set of one or more past time resources, at least one modulation and coding scheme associated with communications during the set of one or more past time resources, a quantity of resource elements granted by each of the one or more past resource grants communicated during the set of one or more past time resources, a total quantity of resource elements granted by the one or more past resource grants communicated during the set of one or more past time resources, automatic repeat request feedback associated with communications during the set of one or more past time resources, one or more channel state feedback reports associated with communications during the set of one or more past time resources, channeling quality information associated with communications during the set of one or more past time resources, or traffic load information associated with communications during the set of one or more past time resources.

In a sixth aspect, alone or in combination with one or more of the first through fifth aspects, the prompt indicates one or more of a quantity of time resources in the set of one or more past time resources, or the information associated with the set of one or more past time resources.

In a seventh aspect, alone or in combination with one or more of the first through sixth aspects, generating the sequence of tokens comprises generating, in accordance with the prompt, a first set of one or more tokens corresponding to a first time resource of the set of one or more future time resources, wherein the first set of one or more tokens represents one or more communications that are predicted to occur during the first time resource, and generating, in accordance with the prompt and the first set of one or more tokens, a second set of one or more tokens corresponding to a second time resource of the set of one or more time resources, wherein the second set of one or more tokens represents one or more communications that are predicted to occur during the second time resource in accordance with the one or more communications that are predicted to occur during the first time resource.

In an eighth aspect, alone or in combination with one or more of the first through seventh aspects, the prompt indicates one or more parameters associated with the set of one or more future time resources.

In a ninth aspect, alone or in combination with one or more of the first through eighth aspects, the generative AI model is trained using data associated with the network node, wherein the data is mapped to one or more conditions associated with the past communications.

In a tenth aspect, alone or in combination with one or more of the first through ninth aspects, the data associated with the past communications includes one or more of a network node traffic load, one or more network traffic conditions, a traffic class, one or more outer loop operations, or a proportionally fair parameter associated with the network node.

In an eleventh aspect, alone or in combination with one or more of the first through tenth aspects, process 900 includes communicating, prior to a time resource associated with a predicted communication of the one or more predicted communications, using a first adaptive receive state associated with a first quantity of activated receive antennas, wherein communicating according to the ARD state comprises communicating, during the time resource associated with the predicted communication, using a second adaptive receive state associated with a second quantity of activated receive antennas.

In a twelfth aspect, alone or in combination with one or more of the first through eleventh aspects, the second quantity of antennas includes a same quantity of receive antennas as the first quantity of antennas.

In a thirteenth aspect, alone or in combination with one or more of the first through twelfth aspects, the second quantity of antennas is larger than the first quantity of antennas.

In a fourteenth aspect, alone or in combination with one or more of the first through thirteenth aspects, the second quantity of antennas is smaller than the first quantity of antennas.

In a fifteenth aspect, alone or in combination with one or more of the first through fourteenth aspects, the prompt indicates that the generative AI model is to take a hypothetical future scenario into account when generating the sequence of tokens.

In a sixteenth aspect, alone or in combination with one or more of the first through fifteenth aspects, process 900 includes inputting, into the generative AI model, information associated with the set of one or more past time references, and inputting, into the generative AI model, a quantity of time resources to be included in the set of one or more past time resources.

In a seventeenth aspect, alone or in combination with one or more of the first through sixteenth aspects, the prompt requests a set of information from the generative AI model according to a task-specific head of the generative AI model that is associated with predictive link modeling, and the process 900 includes obtaining a set of information from the generative AI model in association with generating the sequence of tokens, wherein the set of information includes the one or more predicted communications.

In an eighteenth aspect, alone or in combination with one or more of the first through seventeenth aspects, process 900 includes selecting a quantity of active receive antennas that correspond to the ARD state according to the one or more predicted communications.

In a nineteenth aspect, alone or in combination with one or more of the first through eighteenth aspects, the generative AI model outputs a prediction for each time resource of the set of one or more future time resources by generating one or more tokens corresponding to each future time resource of the set of one or more future time resources.

In a twentieth aspect, alone or in combination with one or more of the first through nineteenth aspects, process 900 includes obtaining a prediction for each time resource of the set of one or more future time resources, wherein each prediction, after an initial prediction, is generated in association with information corresponding to the set of one or more past time resources and a prediction associated with one or more future time resources preceding the time resource for which the prediction is obtained.

In a twenty-first aspect, alone or in combination with one or more of the first through twentieth aspects, the reference time period occurs after the set of one or more past time resources and before the set of one or more future time resources.

In a twenty-second aspect, alone or in combination with one or more of the first through twenty-first aspects, the one or more predicted communications indicate whether each of the one or more predicted communications will be communicated during the set of one or more future time resources, a future time resource during which at least one of the one or more predicted communications will be communicated, a downlink rank associated with at least one of the one or more predicted communications, a modulation and coding scheme associated with at least one of the one or more predicted communications, a time of arrival associated with at least one of the one or more predicted communications, wherein the set of one or more future time resources includes the time of arrival, whether at least one of the one or more predicted communications will be successfully decoded, a quantity of resource elements associated with at least one of the one or more predicted communications, or a combination thereof.

In a twenty-third aspect, alone or in combination with one or more of the first through twenty-second aspects

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 6-8. Additionally, or alternatively, the apparatus 1000 may be configured to perform one or more processes described herein, such as process 900 of FIG. 9, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The communication manager 1006 may input, during a reference time period, a prompt into a generative artificial intelligence (AI) model, wherein the prompt is associated with a set of one or more past time resources. The communication manager 1006 may generate, during the reference time period and using the generative AI model, a sequence of tokens corresponding to a set of one or more future time resources, wherein the sequence of tokens represents one or more predicted communications between the UE and a network node during the set of one or more future time resources. The reception component 1002 and/or the transmission component 1004 may communicate, with the network node during the set of one or more future time resources, according to an ARD state, wherein the ARD state is selected by the UE according to the one or more predicted communications.

The communication manager 1006 may communicate, prior to a time resource associated with a predicted communication of the one or more predicted communications, using a first adaptive receive state associated with a first quantity of activated receive antennas, wherein communicating according to the ARD state comprises communicating, during the time resource associated with the predicted communication, using a second adaptive receive state associated with a second quantity of activated receive antennas.

The communication manager 1006 may input, into the generative AI model, information associated with the set of one or more past time references.

The communication manager 1006 may input, into the generative AI model, a quantity of time resources to be included in the set of one or more past time resources.

The communication manager 1006 may select a quantity of active receive antennas that correspond to the ARD state according to the one or more predicted communications.

The reception component 1002 may obtain a prediction for each time resource of the set of one or more future time resources, wherein each prediction, after an initial prediction, is generated in association with information corresponding to the set of one or more past time resources and a prediction associated with one or more future time resources preceding the time resource for which the prediction is obtained.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: inputting, during a reference time period, a prompt into a generative artificial intelligence (AI) model, wherein the prompt is associated with a set of one or more past time resources; generating, during the reference time period and using the generative AI model, a sequence of tokens corresponding to a set of one or more future time resources, wherein the sequence of tokens represents one or more predicted communications between the UE and a network node during the set of one or more future time resources; and communicating, with the network node during the set of one or more future time resources, according to an adaptive receive diversity state, wherein the adaptive receive diversity state is selected by the UE according to the one or more predicted communications.

Aspect 2: The method of Aspect 1, wherein generating the sequence of tokens comprises: generating an additional sequence of tokens corresponding to the set of one or more future time resources, wherein the additional sequence of tokens represents a set of one or more parameters associated with the predicted communications.

Aspect 3: The method of any of Aspects 1-2, wherein the set of one or more future time resources include: an initial time resource that is separated from an ending time resource of the reference time period by a variable quantity of time slots, and a variable quantity of time resources subsequent to the initial time resource.

Aspect 4: The method of any of Aspects 1-3, wherein generating the sequence of tokens comprises: generating the sequence of tokens in accordance with information associated with the set of one or more past time resources.

Aspect 5: The method of Aspect 4, wherein the set of one or more past time resources include: a time resource that is separated from an initial time resource of the reference time period by a variable quantity of time slots, and a variable quantity of time resources relative to the time resource.

Aspect 6: The method of Aspect 4, wherein the information associated with the set of one or more past time resources includes one or more of: one or more past resource grants communicated during the set of one or more past time resources, one of more spectral efficiency values associated with the one or more past resource grants, at least one downlink rank associated with communications during the set of one or more past time resources, at least one modulation and coding scheme associated with communications during the set of one or more past time resources, a quantity of resource elements granted by each of the one or more past resource grants communicated during the set of one or more past time resources, a total quantity of resource elements granted by the one or more past resource grants communicated during the set of one or more past time resources, hybrid automatic repeat request feedback associated with communications during the set of one or more past time resources, one or more channel state feedback reports associated with communications during the set of one or more past time resources, channel quality information associated with communications during the set of one or more past time resources, or traffic load information associated with communications during the set of one or more past time resources.

Aspect 7: The method of Aspect 4, wherein the prompt indicates one or more of: a quantity of time resources in the set of one or more past time resources, or the information associated with the set of one or more past time resources.

Aspect 8: The method of any of Aspects 1-7, wherein generating the sequence of tokens comprises: generating, in accordance with the prompt, a first set of one or more tokens corresponding to a first time resource of the set of one or more future time resources, wherein the first set of one or more tokens represents one or more communications that are predicted to occur during the first time resource; and generating, in accordance with the prompt and the first set of one or more tokens, a second set of one or more tokens corresponding to a second time resource of the set of one or more time resources, wherein the second set of one or more tokens represents one or more communications that are predicted to occur during the second time resource in accordance with the one or more communications that are predicted to occur during the first time resource.

Aspect 9: The method of any of Aspects 1-8, wherein the prompt indicates one or more parameters associated with the set of one or more future time resources.

Aspect 10: The method of any of Aspects 1-9, wherein the generative AI model is trained using data associated with the network node, wherein the data is mapped to one or more conditions associated with the past communications.

Aspect 11: The method of Aspect 10, wherein the data includes one or more of: a network node traffic load, one or more network traffic conditions, a traffic class, one or more outer loop operations, or a proportionally fair parameter associated with the network node.

Aspect 12: The method of any of Aspects 1-11, further comprising: communicating, prior to a time resource associated with a predicted communication of the one or more predicted communications, using a first adaptive receive state associated with a first quantity of activated receive antennas, wherein communicating according to the adaptive receive diversity state comprises: communicating, during the time resource associated with the predicted communication, using a second adaptive receive state associated with a second quantity of activated receive antennas.

Aspect 13: The method of Aspect 12, wherein the second quantity of antennas includes a same quantity of receive antennas as the first quantity of antennas.

Aspect 14: The method of Aspect 12, wherein the second quantity of antennas is larger than the first quantity of antennas.

Aspect 15: The method of Aspect 12, wherein the second quantity of antennas is smaller than the first quantity of antennas.

Aspect 16: The method of any of Aspects 1-15, wherein the prompt indicates that the generative AI model is to take a hypothetical future scenario into account when generating the sequence of tokens.

Aspect 17: The method of any of Aspects 1-16, further comprising: inputting, into the generative AI model, information associated with the set of one or more past time references; and inputting, into the generative AI model, a quantity of time resources to be included in the set of one or more past time resources.

Aspect 18: The method of any of Aspects 1-17, wherein the prompt requests a set of information from the generative AI model according to a task-specific head of the generative AI model that is associated with predictive link modeling, the method further comprising: obtaining a set of information from the generative AI model in association with generating the sequence of tokens, wherein the set of information includes the one or more predicted communications.

Aspect 19: The method of any of Aspects 1-18, further comprising: selecting a quantity of active receive antennas that correspond to the adaptive receive diversity state according to the one or more predicted communications.

Aspect 20: The method of any of Aspects 1-19, wherein the generative AI model outputs a prediction for each time resource of the set of one or more future time resources by generating one or more tokens corresponding to each future time resource of the set of one or more future time resources.

Aspect 21: The method of any of Aspects 1-20, further comprising: obtaining a prediction for each time resource of the set of one or more future time resources, wherein each prediction, after an initial prediction, is generated in association with information corresponding to the set of one or more past time resources and a prediction associated with one or more future time resources preceding the time resource for which the prediction is obtained.

Aspect 22: The method of any of Aspects 1-21, wherein the reference time period occurs after the set of one or more past time resources and before the set of one or more future time resources.

Aspect 23: The method of any of Aspects 1-22, wherein the one or more predicted communications indicate one or more of: whether each of the one or more predicted communications will be communicated during the set of one or more future time resources, a future time resource during which at least one of the one or more predicted communications will be communicated, a downlink rank associated with at least one of the one or more predicted communications, a modulation and coding scheme associated with at least one of the one or more predicted communications, a time of arrival associated with at least one of the one or more predicted communications, wherein the set of one or more future time resources includes the time of arrival, whether at least one of the one or more predicted communications will be successfully decoded, a quantity of resource elements associated with at least one of the one or more predicted communications, or a combination thereof.

Aspect 24: A method of wireless communication performed by a network node, comprising: communicating one or more messages with a user equipment (UE) that is communicating according to a first adaptive receive diversity state of the UE; and communicating one or more messages with a UE implementing an adaptive receive diversity state during a set of one or more future time resources, wherein the adaptive receive diversity state is selected by the UE according to a sequence of tokens that are generated by a generative artificial intelligence (genAI) model and that correspond to the set of one or more future time resources, and wherein the sequence of tokens represents one or more predicted communications between the UE and a network node during the set of one or more future time resources.

Aspect 25: The method of Aspect 24, wherein the set of one or more future time resources include: an initial time resource that is separated from an ending time resource of a reference time period by a variable quantity of time slots, and a variable quantity of time resources subsequent to the initial time resource.

Aspect 26: The method of any of Aspects 24-25, wherein the sequence of tokens is associated with information associated with a set of one or more past time resources.

Aspect 27: The method of Aspect 26, wherein the set of one or more past time resources include: a time resource that is separated from an initial time resource of the reference time period by a variable quantity of time slots, and a variable quantity of time resources relative to the time resource.

Aspect 28: The method of Aspect 26, wherein the information associated with the set of one or more past time resources includes one or more of: one or more past resource grants communicated during the set of one or more past time resources, one of more spectral efficiency values associated with the one or more past resource grants, at least one downlink rank associated with communications during the set of one or more past time resources, at least one modulation and coding scheme associated with communications during the set of one or more past time resources, a quantity of resource elements granted by each of the one or more past resource grants communicated during the set of one or more past time resources, a total quantity of resource elements granted by the one or more past resource grants communicated during the set of one or more past time resources, hybrid automatic repeat request feedback associated with communications during the set of one or more past time resources, one or more channel state feedback reports associated with communications during the set of one or more past time resources, channel quality information associated with communications during the set of one or more past time resources, or traffic load information associated with communications during the set of one or more past time resources.

Aspect 29: The method of any of Aspects 24-28, wherein the generative AI model is trained using data associated with the network node, wherein the data is mapped to one or more conditions associated with the past communications.

Aspect 30: The method of Aspect 29, wherein the data includes one or more of: a network node traffic load, one or more network traffic conditions, a traffic class, one or more outer loop operations, or a proportionally fair parameter associated with the network node.

Aspect 31: The method of any of Aspects 24-30, wherein the generative AI model outputs a prediction for each time resource of the set of one or more future time resources by generating one or more tokens corresponding to each future time resource of the set of one or more future time resources.

Aspect 32: The method of any of Aspects 24-31, wherein a reference time period occurs after a set of one or more past time resources and before the set of one or more future time resources.

Aspect 33: The method of any of Aspects 24-32, wherein the one or more predicted communications indicate one or more of: whether each of the one or more predicted communications will be communicated during the set of one or more future time resources, a future time resource during which at least one of the one or more predicted communications will be communicated, a downlink rank associated with at least one of the one or more predicted communications, a modulation and coding scheme associated with at least one of the one or more predicted communications, a time of arrival associated with at least one of the one or more predicted communications, wherein the set of one or more future time resources includes the time of arrival, whether at least one of the one or more predicted communications will be successfully decoded, a quantity of resource elements associated with at least one of the one or more predicted communications, or a combination thereof.

Aspect 34: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-33.

Aspect 35: An apparatus for wireless communication at a device, the apparatus comprising one or more memories and one or more processors coupled to the one or more memories, the one or more processors configured to cause the device to perform the method of one or more of Aspects 1-33.

Aspect 36: An apparatus for wireless communication, the apparatus comprising at least one means for performing the method of one or more of Aspects 1-33.

Aspect 37: A non-transitory computer-readable medium storing code for wireless communication, the code comprising instructions executable by one or more processors to perform the method of one or more of Aspects 1-33.

Aspect 38: A non-transitory computer-readable medium storing a set of instructions for wireless communication, the set of instructions comprising one or more instructions that, when executed by one or more processors of a device, cause the device to perform the method of one or more of Aspects 1-33.

Aspect 39: A device for wireless communication, the device comprising a processing system that includes one or more processors and one or more memories coupled with the one or more processors, the processing system configured to cause the device to perform the method of one or more of Aspects 1-33.

Aspect 40: An apparatus for wireless communication at a device, the apparatus comprising one or more memories and one or more processors coupled to the one or more memories, the one or more processors individually or collectively configured to cause the device to perform the method of one or more of Aspects 1-33.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
input, during a reference time period, a prompt into a generative artificial intelligence (AI) model, wherein the prompt is associated with a set of one or more past time resources;
generate, during the reference time period and using the generative AI model, a sequence of tokens corresponding to a set of one or more future time resources, wherein the sequence of tokens represents one or more predicted communications between the UE and a network node during the set of one or more future time resources; and
communicate, with the network node during the set of one or more future time resources, according to an adaptive receive diversity state, wherein the adaptive receive diversity state is selected by the UE according to the one or more predicted communications.

2. The apparatus of claim 1, wherein the one or more processors, to cause the UE to generate the sequence of tokens, are configured to cause the UE to:
generate an additional sequence of tokens corresponding to the set of one or more future time resources, wherein the additional sequence of tokens represents a set of one or more parameters associated with the predicted communications.

3. The apparatus of claim 1, wherein the set of one or more future time resources include:
an initial time resource that is separated from an ending time resource of the reference time period by a variable quantity of time slots, and
a variable quantity of time resources subsequent to the initial time resource.

4. The apparatus of claim 1, wherein the one or more processors, to cause the UE to generate the sequence of tokens, are configured to cause the UE to:
generate the sequence of tokens in accordance with information associated with the set of one or more past time resources.

5. The apparatus of claim 4, wherein the set of one or more past time resources include:
a time resource that is separated from an initial time resource of the reference time period by a variable quantity of time slots, and
a variable quantity of time resources relative to the time resource.

6. The apparatus of claim 4, wherein the information associated with the set of one or more past time resources includes one or more of:
one or more past resource grants communicated during the set of one or more past time resources,
one of more spectral efficiency values associated with the one or more past resource grants,
at least one downlink rank associated with communications during the set of one or more past time resources,
at least one modulation and coding scheme associated with communications during the set of one or more past time resources,
a quantity of resource elements granted by each of the one or more past resource grants communicated during the set of one or more past time resources,
a total quantity of resource elements granted by the one or more past resource grants communicated during the set of one or more past time resources,
hybrid automatic repeat request feedback associated with communications during the set of one or more past time resources,
one or more channel state feedback reports associated with communications during the set of one or more past time resources,
channel quality information associated with communications during the set of one or more past time resources, or
traffic load information associated with communications during the set of one or more past time resources.

7. The apparatus of claim 4, wherein the prompt indicates one or more of:
a quantity of time resources in the set of one or more past time resources, or
the information associated with the set of one or more past time resources.

8. A method of wireless communication performed by a user equipment (UE), comprising:
inputting, during a reference time period, a prompt into a generative artificial intelligence (AI) model, wherein the prompt is associated with a set of one or more past time resources;
generating, during the reference time period and using the generative AI model, a sequence of tokens corresponding to a set of one or more future time resources, wherein the sequence of tokens represents one or more predicted communications between the UE and a network node during the set of one or more future time resources; and
communicating, with the network node during the set of one or more future time resources, according to an adaptive receive diversity state, wherein the adaptive receive diversity state is selected by the UE according to the one or more predicted communications.

9. The method of claim 8, wherein generating the sequence of tokens comprises:
generating, in accordance with the prompt, a first set of one or more tokens corresponding to a first time resource of the set of one or more future time resources, wherein the first set of one or more tokens represents one or more communications that are predicted to occur during the first time resource; and
generating, in accordance with the prompt and the first set of one or more tokens, a second set of one or more tokens corresponding to a second time resource of the set of one or more future time resources, wherein the second set of one or more tokens represents one or more communications that are predicted to occur during the second time resource in accordance with the one or more communications that are predicted to occur during the first time resource.

10. The method of claim 8, wherein the prompt indicates one or more parameters associated with the set of one or more future time resources.

11. The method of claim 8, wherein the generative AI model is trained using data associated with the network node, wherein the data is mapped to one or more conditions associated with the past communications.

12. The method of claim 11, wherein the data includes one or more of:
a network node traffic load,
one or more network traffic conditions,
a traffic class,
one or more outer loop operations, or
a proportionally fair parameter associated with the network node.

13. The method of claim 8, further comprising:
communicating, prior to a time resource associated with a predicted communication of the one or more predicted communications, using a first adaptive receive state associated with a first quantity of activated receive antennas, wherein communicating according to the adaptive receive diversity state comprises:
communicating, during the time resource associated with the predicted communication, using a second adaptive receive state associated with a second quantity of activated receive antennas.

14. A non-transitory computer-readable medium storing a set of instructions for wireless communication, the set of instructions comprising:
one or more instructions that, when executed by one or more processors of a user equipment (UE), cause the UE to:
input, during a reference time period, a prompt into a generative artificial intelligence (AI) model, wherein the prompt is associated with a set of one or more past time resources;
generate, during the reference time period and using the generative AI model, a sequence of tokens corresponding to a set of one or more future time resources, wherein the sequence of tokens represents one or more predicted communications between the UE and a network node during the set of one or more future time resources; and
communicate, with the network node during the set of one or more future time resources, according to an adaptive receive diversity state, wherein the adaptive receive diversity state is selected by the UE according to the one or more predicted communications.

15. The non-transitory computer-readable medium of claim 14, wherein the prompt indicates that the generative AI model is to take a hypothetical future scenario into account when generating the sequence of tokens.

16. The non-transitory computer-readable medium of claim 14, wherein the one or more instructions further cause the UE to:
input, into the generative AI model, information associated with the set of one or more past time references; and
input, into the generative AI model, a quantity of time resources to be included in the set of one or more past time resources.

17. The non-transitory computer-readable medium of claim 14, wherein the one or more instructions further cause the UE to:
obtain a set of information from the generative AI model in association with generating the sequence of tokens, wherein the set of information includes the one or more predicted communications.

18. The non-transitory computer-readable medium of claim 14, wherein the one or more instructions further cause the UE to:
select a quantity of active receive antennas that correspond to the adaptive receive diversity state according to the one or more predicted communications.

19. The non-transitory computer-readable medium of claim 14, wherein the one or more instructions further cause the UE to:
obtain a prediction for each time resource of the set of one or more future time resources, wherein each prediction, after an initial prediction, is generated in association with information corresponding to the set of one or more past time resources and a prediction associated with one or more future time resources preceding the time resource for which the prediction is obtained.

20. The non-transitory computer-readable medium of claim 14, wherein the one or more predicted communications indicate one or more of:
whether each of the one or more predicted communications will be communicated during the set of one or more future time resources,
a future time resource during which at least one of the one or more predicted communications will be communicated,
a downlink rank associated with at least one of the one or more predicted communications,
a modulation and coding scheme associated with at least one of the one or more predicted communications,
a time of arrival associated with at least one of the one or more predicted communications, wherein the set of one or more future time resources includes the time of arrival,
whether at least one of the one or more predicted communications will be successfully decoded,
a quantity of resource elements associated with at least one of the one or more predicted communications, or
a combination thereof.
